(19) United States
(12) Patent Application Publication
(10) Pub. No.: US 2018/0109440 A1
(43) Pub. Date: Apr. 19, 2018

(54) Router and methods of switching with a plurality of link nodes and a single connection map

(71) Applicant: Snell Advanced Media Limited, Berkshire (GB)

(72) Inventor: Michael James Knee, Petersfield (GB)

(21) Appl. No.: 15/783,756

(22) Filed: Oct. 13, 2017

(30) Foreign Application Priority Data
Oct. 19, 2016 (GB) 1617717.2

(51) Int. Cl. H04L 12/721; H04L 12/753; H04L 12/707; H04L 12/751

(52) U.S. Cl. CPC H04L 45/127; H04L 45/02; H04L 45/22; H04L 45/48

(57) ABSTRACT

A router with leaf and spine nodes. Each leaf node is connectable to a spine node, so that a signal from a source leaf node can reach a destination leaf node through a spine node. If no spine node can connect to both the source leaf node and the destination leaf node, the router identifies a first spine node connectable to the source leaf node and a second spine node connectable to the destination leaf node; maps the existing connections between connection elements on the first spine node and maps the existing connections between connection elements on the second spine node; superimposes the existing connections onto a single connection map; identifies a connection tree that comprises the second connection element; and swaps certain connections, if the connection tree does not comprise the first connection element.

### BACKGROUND

This invention relates to routers and methods of switching and is concerned in certain embodiments to reduce the number of connection failures in a router.

Many networks and routers have been designed so that messages and signals can be sent from one node to another. Many of these networks are devised so that connections can be made across a network from a source to a destination node via crosspoint switches (in a crosspoint switch layout such as an M×N switch router or in a spine-leaf configuration). However, there is no industry solution that allows for connections from a source to many destinations in a crosspoint switch network to be made without comprising the ability to make further connections across the network.

The idea of using a crosspoint switch network is not new. However, solutions such as the one disclosed by Charles Clos are not well suited to the requirements on routers for use in broadcast applications. This type of router does not enable the fanout of connections in a spine-leaf network to occur. The ability to perform fanout (when appropriate) is a necessity when broadcasting for example video streams through a router from one source node to many destination nodes.

### SUMMARY

A method for utilising a switching resource having a plurality of nodes, including a source node, a destination node, and a plurality of link nodes, comprises the steps of:
identifying a first link node connected or connectable to the source node and a second link node connectable to the destination node, the first link node and the second link node both comprising connection elements;
mapping the existing connections between connection elements on the first link node and mapping the existing connections between connection elements on the second link node;
superimposing said existing connections onto a single connection map;
identifying one or more separate connection trees, wherein each tree is formed of a continuous path of existing connections between connection elements across the connection map;
identifying if a connection element in the connection map connectable to the source node and a connection element in the connection map connectable to the destination node are part of separate connection trees;
swapping, in the event that the connection element connectable to the source node and the connection element connectable to the destination node are part of separate connection trees, the existing connections on the first link node that form part of one of said connection trees comprising the connection element connectable to the source node, with the existing connections on the second link node that form part of the same tree.

The invention will now be described by way of example with reference to the accompanying drawings, in which:

### BRIEF DESCRIPTION OF THE DRAWINGS

FIG. 1 shows an M×N cross point router with M×N connections.

FIG. 2 shows the cross point router of FIG. 1 in which some of the connections are active at certain switch points.

FIG. 3 shows a diagram of a spine-leaf network that may be used to replace the type of cross point router of FIG. 1.

FIG. 4 shows the spine-leaf network of FIG. 3, but in an unfolded form so that the bi-directional connections shown in FIG. 3 are now split into connections from inward leaf nodes to the spine nodes and connections from the spine nodes to outward leaf nodes.

FIG. 5 shows a spine-leaf diagram in which a connection cannot be made from inward leaf node 1 to outward leaf node 1 without a redistribution of the existing connections.

FIG. 6 shows a spine-leaf diagram in which the existing connections of FIG. 5 have been redistributed in order to allow a connection from inward leaf node 1 to outward leaf node 1 to be made.

FIG. 7 shows a spine-leaf diagram in which a connection cannot be made from inward leaf node 1 to outward leaf node 1 without a redistribution of the existing connections.

FIG. 8 shows a spine-leaf diagram in which the existing connections of FIG. 7 have been redistributed in order to allow a connection from inward leaf node 1 to outward leaf node 1 to be made.

FIG. 9 shows a spine-leaf diagram in which a connection cannot be made from inward leaf node 2 to outward leaf node 3 without a redistribution of the existing connections.

FIG. 10 shows a spine-leaf diagram in which the existing connections of FIG. 9 have been redistributed in order to allow a connection from inward leaf node 2 to outward leaf node 3 to be made.

FIG. 11 shows the existing connections across a first spine node (also known as a link node) and a second spine node.

FIG. 12 shows the existing connections across the first and second spine nodes superimposed on a notional spine node with the connection trees across the notional spine node identified.

FIG. 13 shows the redistribution of the existing connections that comprised the bold connection tree of FIG. 12 to allow a connection between the first connection element and second connection element on the second spine node.

FIG. 14 shows the existing connections across a first spine node and a second spine node.

FIG. 15 shows the existing connections across the first and second spine nodes superimposed to form a connection map with the connection trees across the map identified.

FIG. 16 shows the redistribution of some of the existing connections that comprised the bold connection tree of FIG. 15 to allow a connection between the first connection element and second connection element on the second spine node.

FIG. 17 shows the existing connections across a first and a second spine node.

FIG. 18 shows the existing connections superimposed on a connection map to show that a single connection tree in bold comprises both the first connection element and the second connection element and so no redistribution can be made to enable to a new connection between the first and second connection elements to be available.

FIG. 19 shows a flow diagram showing one embodiment of a method that can be used to redistribute the existing connections across a first and a second spine node to allow for a new connection.

FIG. 20 shows a flow diagram showing one embodiment of a method that can be used to attempt to form a connection between a source leaf node and a destination leaf node.

### DETAILED DESCRIPTION OF EMBODIMENTS

A router for directing signals may comprise a plurality of leaf nodes, where each leaf node comprises at least one connection element; and a a plurality of spine nodes, where each spine node comprises at least two connection elements.

Each leaf node is connectable to at least one spine node through a connection between one of the at least one connection element of the leaf node and one of the at least two connection elements of the spine node and the router is configured so that a signal from a source leaf node can reach a destination leaf node through a spine node.

In the event no spine node can connect to both the source leaf node and the destination leaf node, the network is configured to:
identify a first spine node connected or connectable to the source leaf node and a second spine node connectable to the destination leaf node;
map the existing connections between connection elements on the first spine node and map the existing connections between connection elements on the second spine node;
superimpose said existing connections onto a single connection map;
identify a connection tree that comprises the second connection element, wherein each connection tree is formed of a continuous path of existing connections between connection elements;
swap, in the event the connection tree does not comprise the first connection element, the existing connections on the second spine node that form part of the connection tree, with the existing connections on the first spine node that form part of the connection tree.

Connections may be formed from the source leaf node to one of the first or second spine nodes, and a connection from the chosen spine node to the destination leaf node.

A signal may be directed from the source leaf node to the destination leaf node through one of the first and second spine nodes.

Forming a connection from the source leaf node to one of the first or second spine node, and a connection from the chosen spine node to the destination leaf node may comprise fanning out an existing connection between the source leaf node to the chosen spine node, and connecting the fanned out connection with the connection element of the chosen spine node connectable to the destination node and then connecting the fanned out connection to the destination node.

Forming a connection from the source leaf node to one of the first or second spine node, and a connection from the chosen spine node to the destination leaf node may comprise fanning out an existing connection between the chosen spine node and the destination leaf node at the destination leaf node.

A spine node with at least two unused connection elements may be identified, where the first unused connection element is connectable to the source leaf node, and where the second unused connection element is connectable to the destination leaf node, a connection can then be made across the spine node between the unused spine node connection elements, in the event that such a spine cannot be identified performing the steps described above.

The router may unblock the connection elements of the source leaf node by fanning out one or more connections.

The swapping of the connections may be done seamlessly so that signals sent along the swapped routes are not affected. A buffer may be used to ensure the swapping is seamless. Connections parallel to the spine node may also be utilised to ensure seamless swapping.

In the event that swapping cannot take place, a route may be found from the first spine node to a third leaf node, back to a third spine node, and then to the destination leaf node.

The spine nodes may be formed of multiple stages.

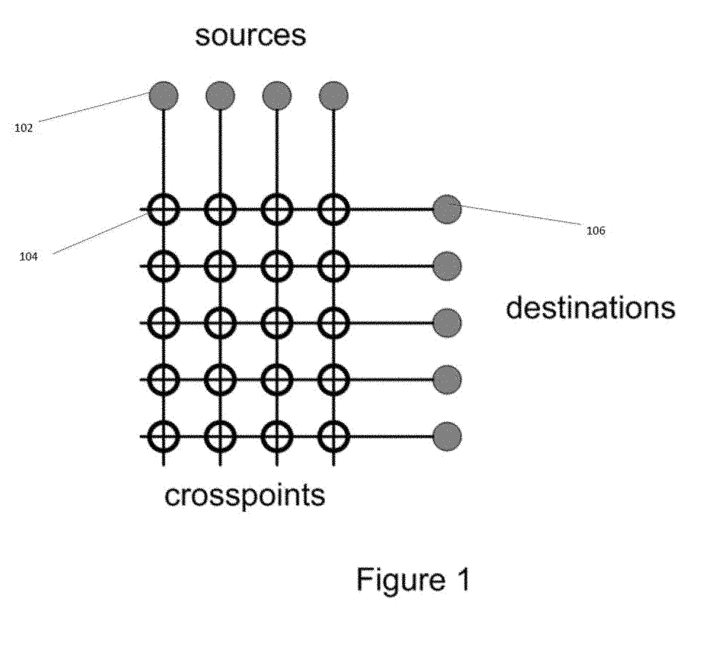

FIG. 1 illustrates a basic cross point router. This shows that a plurality of sources 102 may be connected to a plurality of destinations 106 via a plurality of cross points 104. In this cross point router each and every connection between a source 102 and a destination 106 has its own cross point switch 104 (In some embodiments some of these connections may be missing from the router if a connection between a source and a destination will never, or can never, be made). This means that if there are M sources 102 and N destinations 106 typically there will be M×N number of cross points 104. A typical router will have well in excess of 1000 sources 102 and destinations 106, therefore this means that in a typical router more than 1000000 cross points would be required.

Under normal use the router of FIG. 1 would not be at, or nearly at, full capacity. Therefore the cross point router of FIG. 1 would have a large amount of redundancy for a large amount of the time during use. In general, every row (signifying a destination) can have at most one connection with a source at any given time. This means that of all the cross points in a row only one can be in use at any one time. The rest are therefore redundant.

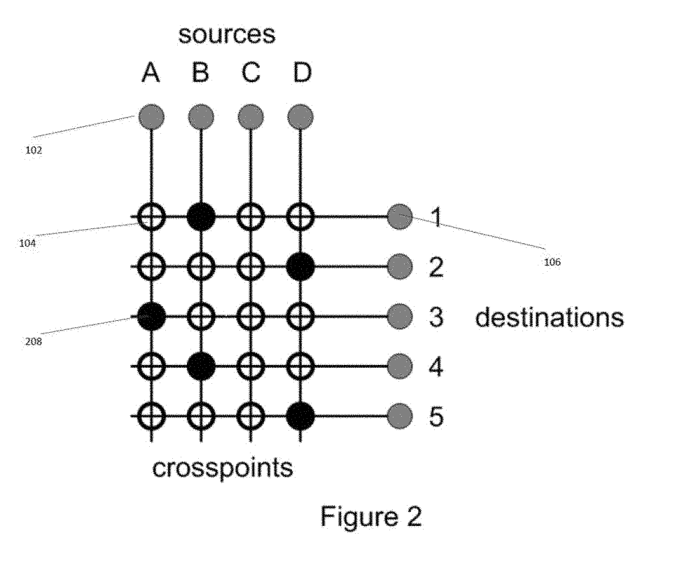

FIG. 2 illustrates the cross point router of FIG. 1 in use. In the example shown in FIG. 2 some of the cross point switches are highlighted black 208. This indicates that they are active. In this instance source A is connected to destination 3, source B is connected to destination 1, source C is not connected to a destination and source D is connected to destinations 2 and 5. Clearly in this instance a large number of the cross points are not in use.

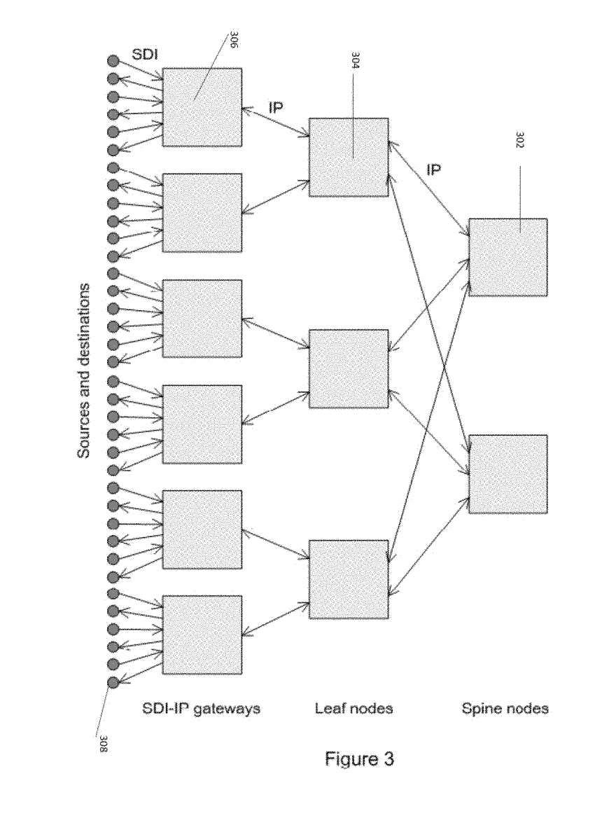

FIG. 3 shows an alternative router configuration to the M×N cross point switch that is typically used in IP router architectures. This shows a spine-leaf network that is designed to reduce the amount of cross point switches in the router, and so reduce the amount of redundancy. FIG. 3 shows each of the source 308 and destination nodes connected to gateway nodes 306 which are in turn connected to leaf nodes 304 and spine nodes 302. The connections between the leaf nodes 304 and spine nodes 306 allow any source and destination node pairing 308 to be connected. In one example, for use in an IP architecture, FIG. 3 shows 18 Serial Digital Interface (SDI) video sources and 18 SDI destinations connected to six SDI-IP gateways, each of which multiplexes three SDI signals in each direction onto a bidirectional IP link. The six IP links are connected to three leaf nodes, which are bidirectional IP switches, each of which may select for each of its two right-hand output IP connections any combination of three video streams present at its left-hand input IP connections, and vice versa for right-to-left flows. Seen in terms of the original video signals, each leaf node is effectively a pair of independent 6×6 crosspoint switches. The six right-hand IP connections on the three leaf nodes are connected to two spine nodes, which are IP switches, each of which can select for each of its three IP outputs any combination of three video streams present at its IP inputs. Seen in terms of the original video signals, each spine node is a 9×9 crosspoint switch. However, this can be simplified to three 3×3 crosspoint switches, since there are three fully configurable connections in each direction from each leaf node. In this instance the number of source and destination nodes 308 is small (there are 18 of each) and so the reduction in the number of cross points is also small. The savings do however increase as the number of source and destination nodes increases.

Various methods of configuring the network shown in FIG. 3 are available. Since the spine nodes are each connected to all the leaf nodes, any particular desired connection can in principle be routed through any spine node. One method of choosing to which spine node a particular stream should be directed is known as equal cost multi-path (ECMP), where the choice of spine node is made at random with the aim of balancing the load across the system. However, in order for ECMP not to fail, a significant amount of headroom in capacity of the leaf-spine connections would be required, making the network quite inefficient. Another alternative, method is to supervise and control the entire network with full knowledge of the desired connections; this is sometimes known as software defined networking (SDN). The embodiments described in relation to the present invention use SDN.

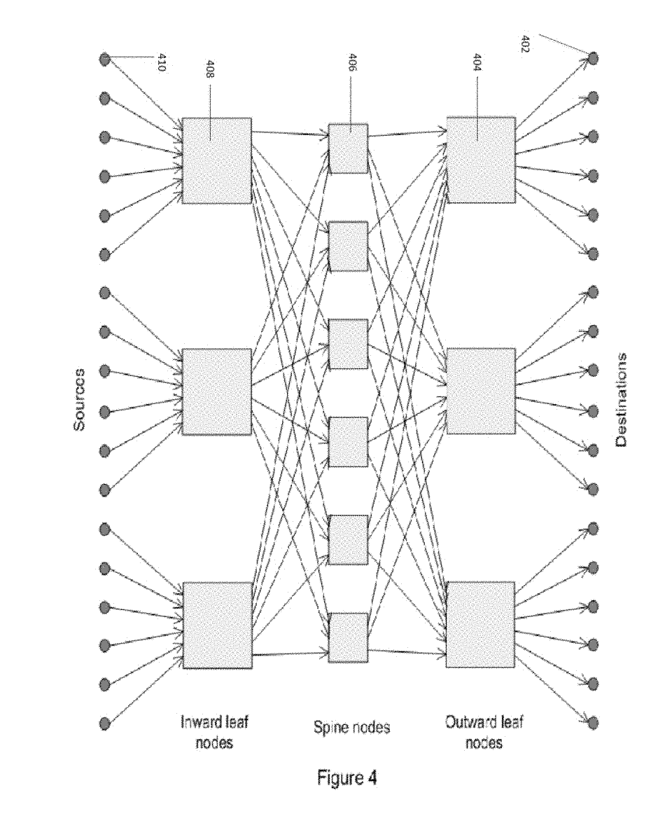

FIG. 4 shows the spine-leaf network of FIG. 3, but in an unfolded form so that the bi-directional connections shown in FIG. 3 are now split into connections from inward leaf nodes 408 to the spine nodes 406 and connections from the spine node 406 to outward leaf nodes 404. The architecture of FIG. 4 is known in telephony as an example of a Clos network, as described by Charles Clos in “A study of non-blocking switching networks”, Bell System Technical Journal 32 (5) pp 406-424, March 1953. That paper describes an algorithm for configuring the cross point switches so that a desired set of source-to-destination connections can be made, but is limited to the case that each source is only connected to one destination.

In order to use the network illustrated in FIG. 4 one connection is added at a time. For each new connection the inward and outward lead nodes that are involved in the connection are identified. As every leaf node 404, 408 is connected to every spine node 406 in this embodiment, one spine node can be found that can be used to make the connection. The identified leaf nodes determine which input and output terminals on the spine nodes have to be used. If a single spine node can be found that has free connections to the required input and output terminals the new connection can be made.

The network shown in FIG. 4 cannot be directly applied to multicast routing as multicast routing requires that a source may be connected to more than one destination at any given time. Multicast routing is used to distribute data to multiple recipients. Another minimum requirement for multicast routing is that all the switch nodes must be capable of connecting an input to multiple outputs, a capability known as fanout.

A Clos network, such as the one shown in FIG. 4, does not satisfy these criteria and therefore when attempting to form connections it may fail in one of two ways. First, if a fanout has been implemented in an inward leaf node, access may be blocked to an as yet unused input terminal. This failure condition is known as a pair failure. Second, even if a suitable pair of spine nodes can be found, it might not be possible to rearrange the existing connections to make room for the new connection. This is a swap failure.

Below is described how these failures may be avoided, and so how a multicast Clos network can be successfully implemented.

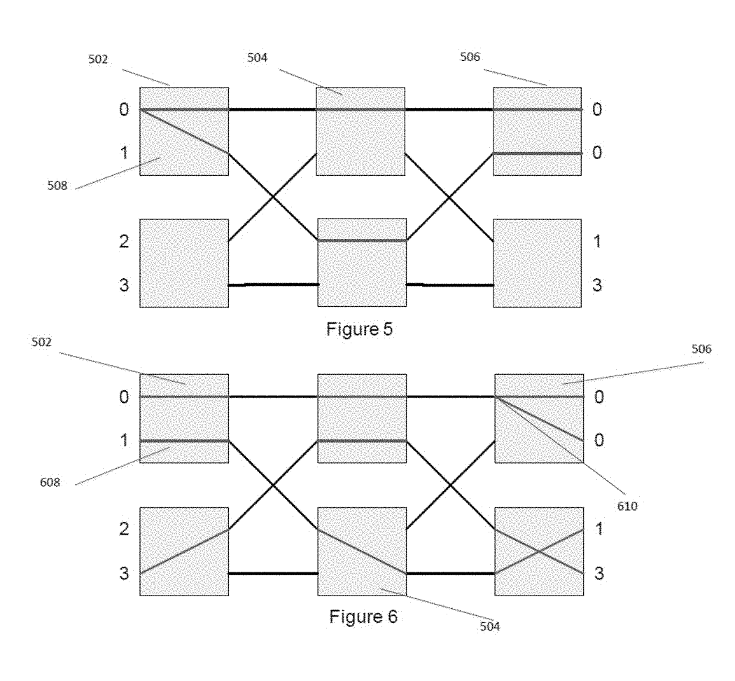

FIGS. 5-10 show examples of a spine-leaf network formed of two 2×2 inward leaf nodes 502, two 2×2 spine nodes 504 and two 2×2 outward leaf nodes 506, to implement a 4×4 router. It is noted that this example is less efficient than a simple 4×4 cross point switch router that would have 16 switches, as opposed to the 24 needed in the example embodiment. This scale is shown purely for simplicity, routers normally comprise more connections (and so spine-leaf networks are more efficient as more connections are added). Source streams enter the left inward leaf nodes, are then passed to the middle spine nodes, and finally pass to the right outward leaf nodes. The outward leaf nodes are marked with the number of the inward leaf node they are connected with. It is also noted that these Figures show the “unfolded” network, and so each network may physically be implemented in a manner shown by FIG. 3. In each of FIGS. 5-10 the inward nodes and outward nodes are numbered, with the numbering of both sets of nodes starting at 0.

FIG. 5 shows a configuration in which both connection elements of the top inward leaf node 502 are used for source 0. Therefore source 1 cannot be connected with a leaf node 508.

FIG. 6 shows the solution to this problem. Rather than fanout source 0 at the inward leaf node 502, fanout 610 can be done at the outward leaf node 506 (as the two destinations are on the same outward leaf node). This enables source 1 to be connected with a spine node and then to the desired outward leaf node and destination node.

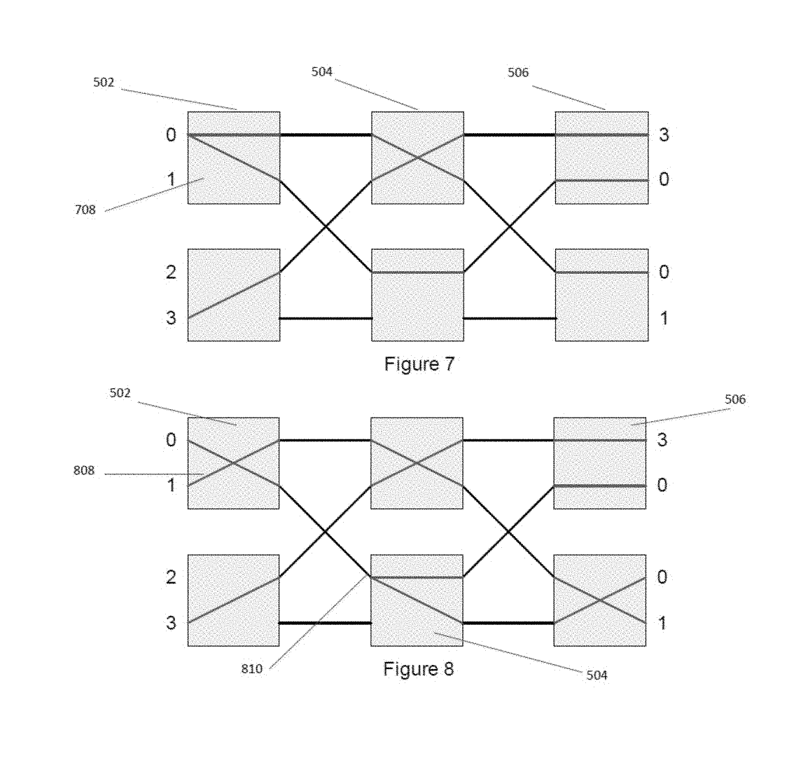

FIG. 7 shows a similar configuration to that shown in FIG. 5. In this instance the main difference between these Figures is that in FIG. 5 source 0 was connected to two destinations connected to a single outward leaf node, whereas in FIG. 7 source 0 is connected to two destinations that are connected to different outward leaf nodes. This means that fanout cannot be done at the outward leaf node. In both cases source 1 is blocked at the inward leaf node 708.

FIG. 8 shows the solution to this problem. In this instance fanout 810 of source 0 takes place at the spine node 504. This allows both desired destinations to be reached. It also allows source 1 to be connected to a spine node through connection 808, and subsequently to an outward leaf node and the desired destination. In some embodiments of the present invention the inward leaf node may be kept unblocked (unless it is determined that other sources connected to the inward leaf node will not form a connection), and fanout may be minimised at the inward leaf node.

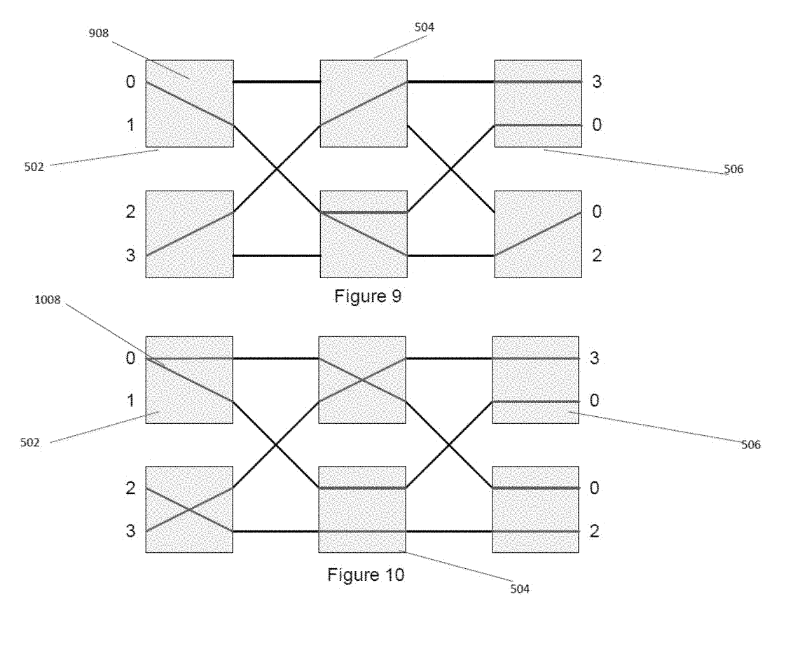

FIG. 9 shows another example in which source 1 is not connected to a destination. It is desired that source 0 is connected with two destinations, one on each of the outward leaf nodes. However, by connecting source 0 with both of the destinations source 2 cannot be connected with its intended destination.

FIG. 10 shows the solution to the problem posed in FIG. 9. In this example the solution is to fanout source 0 at the outward leaf node 1008. This blocks source 1, but as it is known that a connection for source 1 is not required this does not introduce any problems, and allows source 2 to be connected with its desired destination.

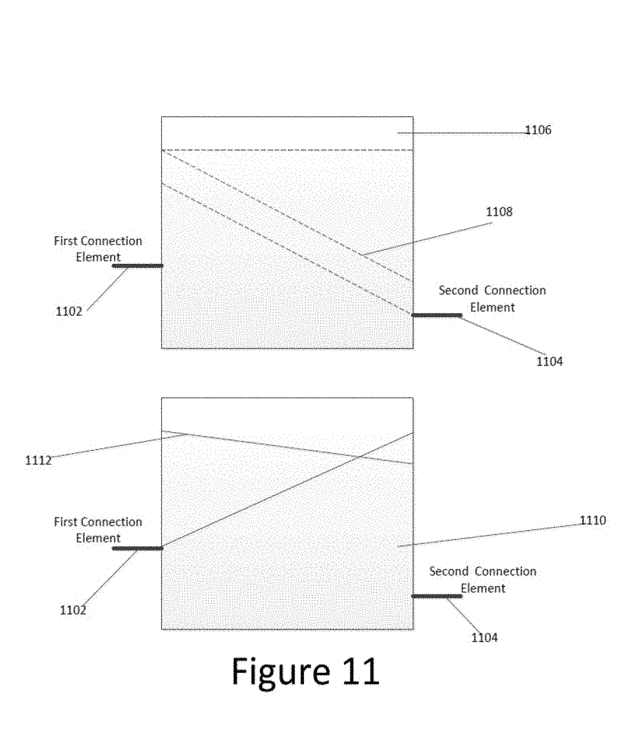

FIGS. 11-18 show two spine nodes. The first spine node (at the top) 1106 has a first connection element 1102 that is connectable (or is already connected) to an inward leaf node connected to a source. This is the source leaf node (or source). The second spine node (at the bottom) 1110 has a second connection element 1104 that is connectable to an outward leaf node connected to a destination. This is the destination leaf node. In the event there is no other spine node that can connect to both the source leaf node and the destination leaf node FIGS. 11-18 show various examples of swapping the existing connections across the spine nodes in order to enable a connection between the source leaf node and the destination leaf node to be formed.

FIG. 11 shows a first spine node 1106 that is connectable to a source leaf node. It currently has three existing connections (shown with dashed lines) 1108. One of these connections is connected to the second connection element and stops the first spine node from being connected with the destination leaf node.

The second spine node 1110 in FIG. 11 has two connections (shown by the full lines) 1112. One of these is from the first connection element and so stops the second spine node from being connected with the source leaf node.

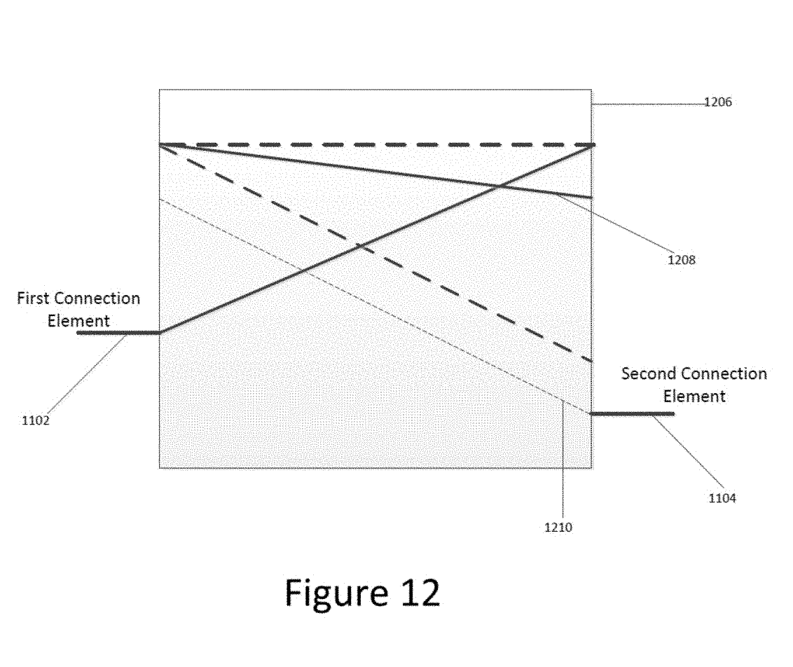

FIG. 12 shows these existing connections on a single diagram 1206. This diagram could be thought of as a connection map, or as a notional spine node. Both the first connection element 1102 and the second connection element 1104 are shown.

The connections in FIG. 12 can be split into two connection trees, otherwise known as connection networks. This is shown by the bold connection tree 1208 and the non-bold connection tree 1210. A connection tree is a continuous path of connections between connection elements (note not all of the connection elements are shown, any point where an existing connection is in contact with the side of the connection map indicates that a connection element is present). In this example the bold connection tree starts at the first connection element 1102, goes up towards the top left of the connection map to a second connection element, and then towards the top right of the map to a third connection element. All of the existing connections connected to these three connection elements form part of the bold connection tree. The only existing connection that does not form part of this tree is shown in non-bold (note more than two trees can be present in a connection map).

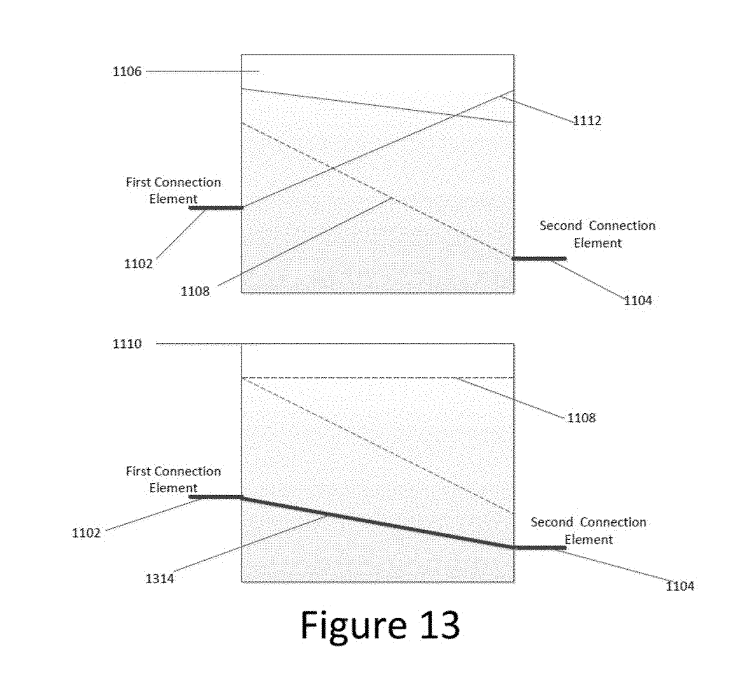

FIG. 13 shows how the existing connections can be redistributed in order to make way so that a new connection between the first connection element 1102 and the second connection element 1104 can be made. The existing connections that make up a connection tree that comprises one (but not both) of the first connection element and the second connection element may be swapped from one spine node to the other to perform the redistribution. In this example the bold tree 1208 from FIG. 12 has been redistributed. All of the bold dashed lines from the first spine node are now present in the second spine node, and all of the bold full lines from the second spine node are now in the first spine node. This allows the second spine node to be used to form a connection between the first connectable element and the second connectable element.

In an alternative embodiment the non-bold tree may have been swapped. In this example the single non-bold dashed line would have swapped from the first spine node to the second spine node. This would allow the first connectable element to be connected with the second connectable element in the first spine node.

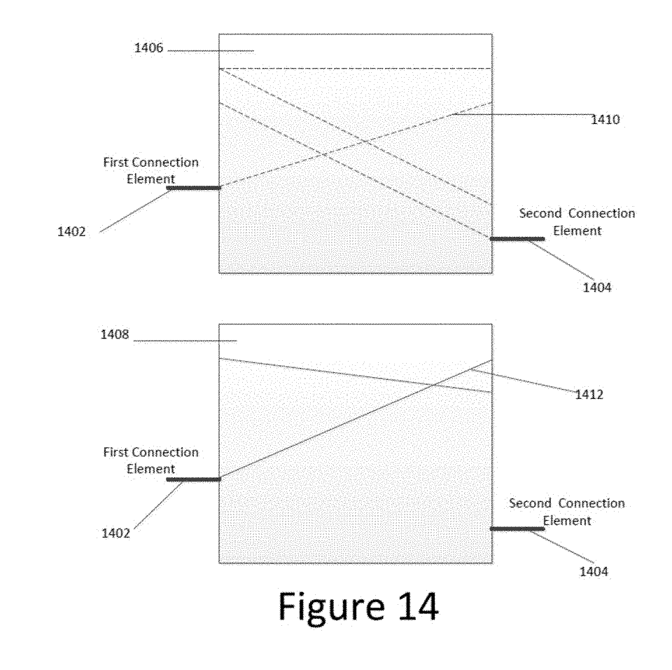

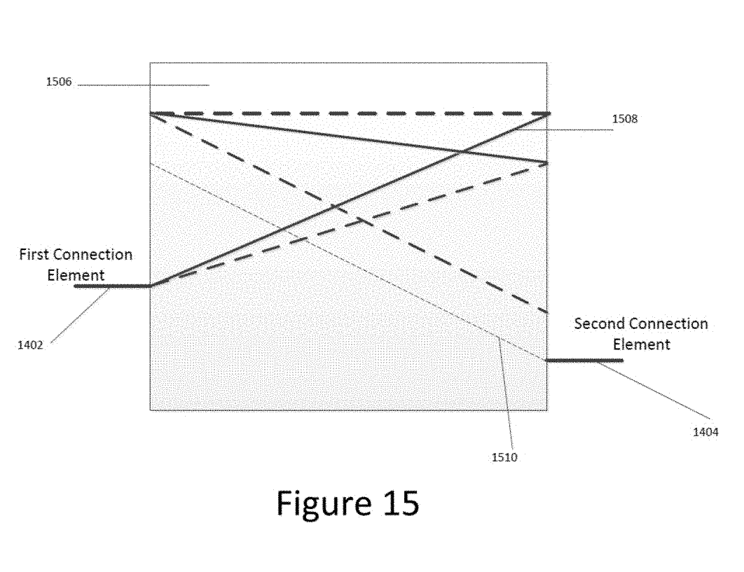

FIG. 14 shows another example of a first spine node 1406 and second spine node 1408 with existing connections 1410 and 1412 respectively. FIG. 15 shows these connections superimposed on a connection map or notional spine node 1506. Once more FIG. 15 (as shown in FIG. 12) shows two connection trees 1510 and 1508. One is bold, and the other is non-bold.

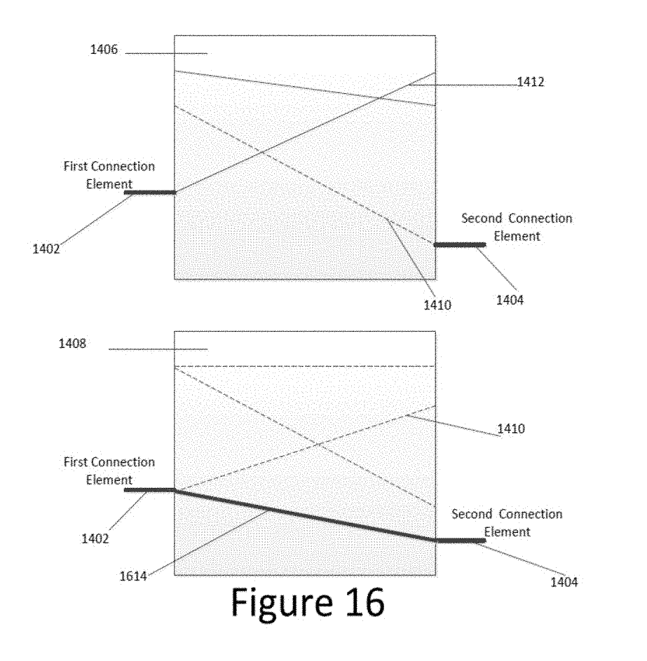

FIG. 16 shows the redistribution of these existing connections. Once more the bold dashed connections from the first spine node have been moved to the second spine node, whilst the bold full lines of the second spine node have been moved to the first spine node. In this example the redistribution of the connections enables the connection connected to the first connection element in the redistributed second spine node to be fanned out. This fanout enables a connection to be achieved between the first connection element and the second connection element 1614. This may be an essential feature in multicast broadcasting, as otherwise it would not be possible to send the source to multiple destinations. In alternative embodiments the router may comprise multiple layers (e.g. the leaf node may be connected to a first spine node stage, which in turn may be connected to a second spine node stage). This would enable fanout to be achieved at each level to reach each destination (there may be a plurality of destinations, especially as the number of sources and destinations are scaled up) as efficiently as possible.

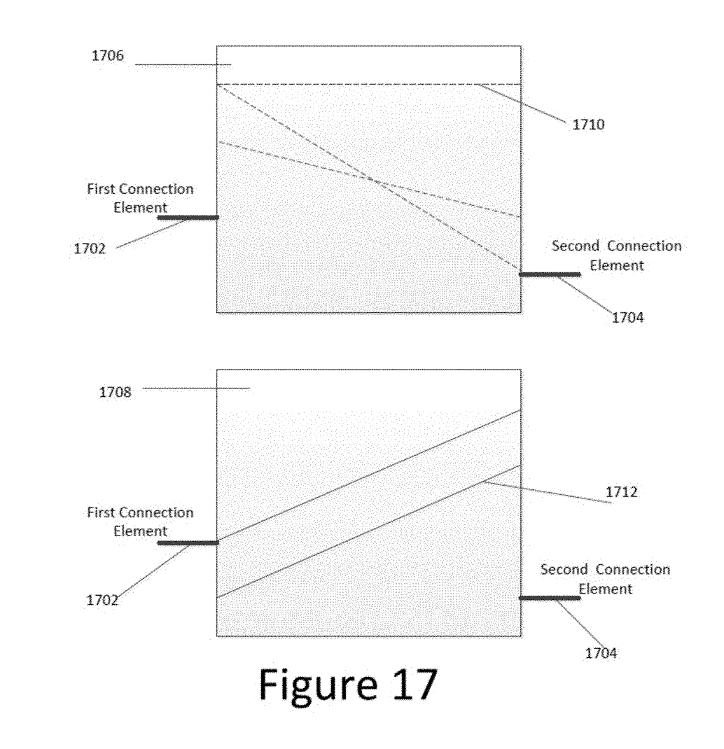

FIG. 17 shows another example of a first spine node 1706 and a second spine node 1708. Both of these show the existing connections across each node 1710 and 1712 respectively.

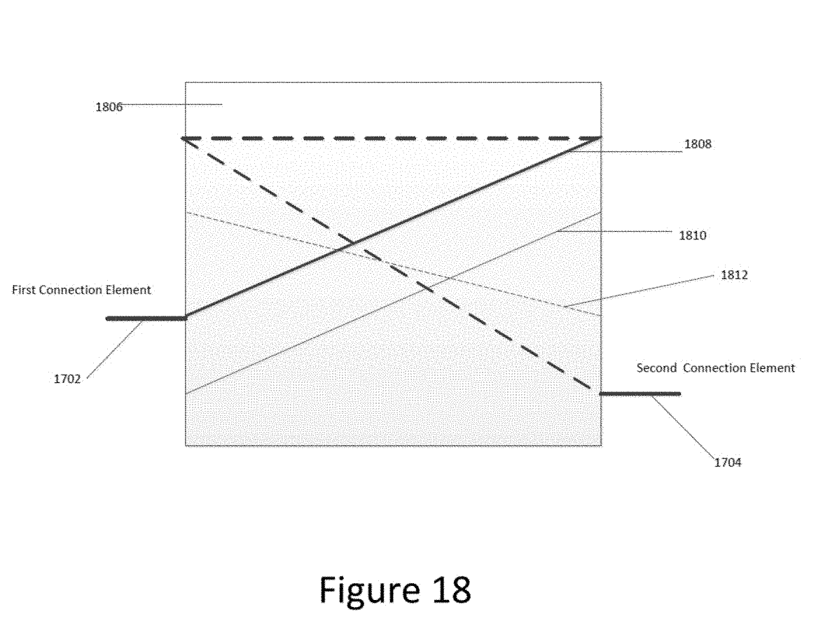

FIG. 18 shows these connections superimposed onto a single connection map 1806. In this example three connection trees are formed. The bold one is the largest tree 1808, whilst the two non-bold connections both form individual connection trees 1810 and 1812. Therefore in this example three connection trees are present. Neither of the non-bold connection trees comprise either the first connection element 1702 or the second connection element 1704. The bold tree comprises both of these elements. This means that regardless of any redistribution it is impossible to form a connection between the first and second connection elements using the pair of the first and second spine nodes.

Alternatives to using the first and second spine nodes include identifying another pair of spine nodes with a third spine node connectable to the source leaf node and a fourth spine node connectable to the destination leaf node (one of the first and second spine nodes may be half of this pair). If this is not possible then other embodiments for forming a connection are envisaged.

One such alternative embodiment may be to route from the source leaf node to the destination leaf node via several intermediate stages. For example, the source leaf node may connect to a first spine node that cannot connect to the destination leaf node (and can also not redistribute the existing connections with any other spine nodes to form a direct connection across one of the spine nodes). This may then connect to a leaf node other than the source or destination leaf nodes. This leaf node may connect to another spine node (different to the first spine node). This spine node may then be able to directly connect to the destination leaf node (or alternatively may be able to redistribute its existing connections with a further spine node to form a direct connection to the destination leaf node).

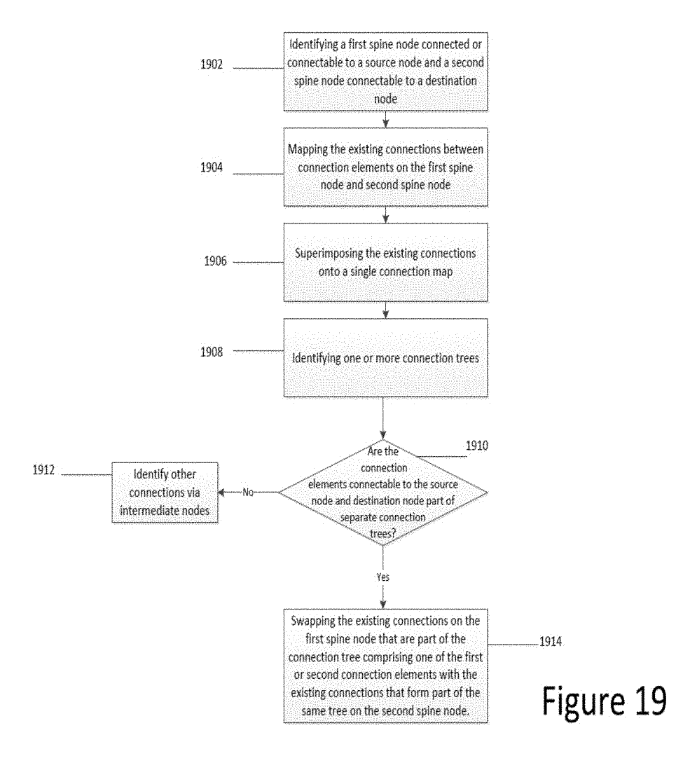

FIG. 19 shows a flow chart that illustrates a method that may be used to perform the swapping (otherwise known as redistribution) of the existing connections across a first and a second spine node.

Several steps are shown in FIG. 19, however additional steps may be added to the flow diagram, and some steps may be amended or deleted. A router and a controller may be configured to perform the method shown in this Figure. The router may correspond with a spine-leaf node network, such as a Clos network. A controller may be comprised of a processor and a memory, or other electronic circuitry.

The first step that is shown in FIG. 19 (although of course other steps may precede it), is that of identifying a first spine node connected or connectable to a source node and a second spine node connectable to a destination node 1902. This step enables the pair of spine nodes to be identified. This may be done in an arbitrary fashion (i.e. any pair of spine nodes that connect to or are connectable with the source leaf node and the destination leaf node may be chosen), or the selection of the pair may be based on some brief analysis of the available spine nodes. For example, a pair of spine nodes are more likely to be able to swap connections to form a direct connection between the first and second connectable elements if the spine nodes have fewer existing connections, therefore of the spine nodes available the ones with the fewest existing connections may be the first ones identified.

Step 1904 discloses mapping the existing connections between connection elements on the first spine node and the second spine node. This enables the rest of the analysis to be completed. It is contemplated that this step may form part of the next one in some embodiments.

Step 1906 discloses superimposing the existing connections onto a single connection map. As stated above the above, the above step and this step may be combined into a single step. Moreover, this step may be replaced by creating a notional spine node that shows the existing connections.

Step 1908 discloses identifying one or more connection trees. This can be done in several ways. In one embodiment each of the connection trees is identified. In another embodiment only the connection tree that comprises the first connection element is identified. In another embodiment only the connection tree that comprises the second connection element is identified. The connection tree may also be referred to as a connection network.

FIG. 19 shows that, in the event that the connection elements connectable to the source node and destination node are part of separate connection trees 1910, the existing connections on the first spine node that form part of a first tree comprising the connection element connectable to the source node, and the existing connections on the second spine node that form part of the same tree may be swapped with one another 1914. This creates the space on one of the spine nodes so that a direct connection between the source leaf node and the destination leaf node can be formed.

In the event that one connection tree does comprise both the first and second connection elements FIG. 19 shows that in one embodiment, the method may identify other connections between the source leaf node and the destination leaf node that may be made via intermediate nodes 1912. In another embodiment another pair of spine nodes may first be analysed to determine whether a direct connection may be made. In yet another embodiment all possible pairs of spine nodes are first analysed to see if a direct connection may first be made between the source leaf node and the destination leaf node before routes that use intermediate nodes are found.

In the event the first and second connection elements are part of separate trees and the existing connections are swapped a connection may be made between the first connection element and the second connection element, and thereby a connection may be made between the source leaf node and the destination leaf node. A message or signal may then be sent between the nodes.

In some embodiments it is necessary that when swapping existing connections the move between nodes is seamless and does not interrupt a connection. In this event redundancy may be used so that the new connection can be made before an existing connection is removed. In one embodiment a parallel router may be utilised to enable the seamless connection to take place. In another embodiment a buffer may be used for this purpose.

The additional connections made to connect the source and leaf node may comprise fanout connections from existing connections. These fanout connections may be in the spine node. There may be multiple new fanout connections at any one time. Alternatively the fanout connections may be at the source leaf node, or at the destination leaf node.

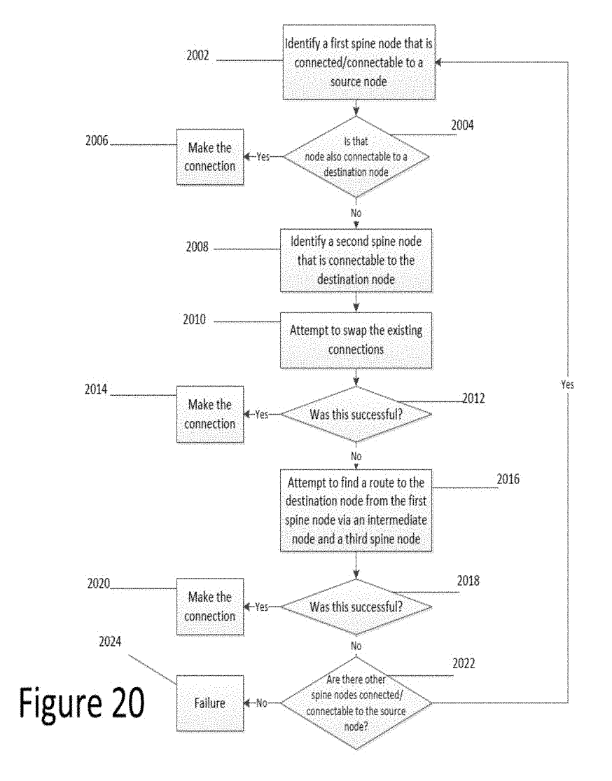

FIG. 20 illustrates a flow chart detailing a method for identifying when the swapping method may be used.

Step 2002 shows identifying a first spine node that is either already connected to, or that is connectable to a source node.

The next step, step 2004, may be recognising if the first spine node is connectable to a destination node. If it is connectable to the destination node a connection should be made 2006.

In the event that a connection cannot be made, step 2008, discloses identifying a second spine node that is connectable to the destination node.

Step 2010 then discloses performing the swapping method shown in FIG. 19 on the first and second spine nodes.

If this swapping method is successful the connection between the source and destination nodes should be made 2014. If however this is not successful an attempt should be made to find a route to the destination node from the first spine node via an intermediate node and a third spine node 2016.

If this is possible then a connection should be made via the intermediate node and the third spine node 2020. If it is not possible then either spine nodes connected or connectable to the source node should be considered and the method should be restarted with one of these as the first spine node. If there are no other spine nodes that are either connected to or connectable to the source node then the method has failed as a connection cannot be made 2024.

It is contemplated that all of the spine nodes connectable to the source node are first checked to determine whether a direct connection can be made. It is also contemplated that if the attempt to swap the connections fails, all of the pairs of spine nodes connected to or connectable to the source node are checked to determine whether a swap is possible to create a direct connection between the source node and the destination node. It is also contemplated that all of the spine nodes connected to or connectable to the source node are checked to determine whether an indirect connection via an intermediate node and a third spine node can be made. If more than one route is possible a route may be picked based on being more direct, or based upon routing to a third spine node that has less existing connections.

It will be appreciated from the discussion above that the embodiments shown in the Figures are merely exemplary, and include features which may be generalised, removed or replaced as described herein and as set out in the claims. With reference to the drawings in general, it will be appreciated that schematic functional block diagrams are used to indicate functionality of systems and apparatus described herein. For example the steps shown in FIGS. 19 and 20 may be combined into single steps. These steps may also be performed on a single apparatus, or each step may be performed at a separate apparatus. The apparatus performing the method steps may include a data storage and a processor (alternatively the router or controller configured for performing the method may comprise a processor and a data storage). Alternatively the functionality provided by the data storage may in whole or in part be provided by the processor. In addition the processing functionality may also be provided by devices which are supported by an electronic device. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein.

The processor of any apparatus used to perform the method steps (and any of the activities and apparatus outlined herein) may be implemented with fixed logic such as assemblies of logic gates or programmable logic such as software and/or computer program instructions executed by a processor. Other kinds of programmable logic include programmable processors, programmable digital logic (e.g., a field programmable gate array (FPGA), an erasable programmable read only memory (EPROM), an electrically erasable programmable read only memory (EEPROM)), an application specific integrated circuit, ASIC, or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof.

1. A method for utilising a switching resource having a plurality of nodes, including a source node, a destination node, and a plurality of link nodes, comprising the steps of:
identifying a first link node connected or connectable to the source node and a second link node connectable to the destination node, the first link node and the second link node both comprising connection elements;
mapping the existing connections between connection elements on the first link node and mapping the existing connections between connection elements on the second link node;
superimposing said existing connections onto a single connection map;
identifying one or more separate connection trees, wherein each tree is formed of a continuous path of existing connections between connection elements across the connection map;
identifying if a connection element in the connection map connectable to the source node and a connection element in the connection map connectable to the destination node are part of separate connection trees;
swapping, in the event that the connection element connectable to the source node and the connection element connectable to the destination node are part of separate connection trees, the existing connections on the first link node that form part of one of said connection trees comprising the connection element connectable to the source node, with the existing connections on the second link node that form part of the same tree.

2. The method of claim 1, further comprising forming a connection from the source node to one of the first or second link nodes, and a connection from the chosen link node to the destination node.

3. The method of claim 1, further comprising directing a signal from the source node to the destination node through one of the first and second link nodes.

4. The method of claim 2, wherein forming a connection from the source node to one of the first or second link node, and a connection from the chosen link node to the destination node comprises fanning out an existing connection between the source node and the chosen link node, and connecting the fanned out connection with the connection element of the chosen link node connectable to the destination node and then connecting the fanned out connection to the destination node.

5. The method of claim 2, wherein forming a connection from the source node to one of the first or second link node, and a connection from the chosen link node to the destination node comprises fanning out an existing connection between the chosen link node and the destination node at the destination node.

6. The method of claim 1, further comprising first identifying a link node with at least two unused connection elements, wherein the first unused connection element is connectable to the source node, and wherein the second unused connection element is connectable to the destination node, wherein a connection can be made across the link node between the unused link node connection elements, and in the event such a link cannot be identified performing the other steps.

7. The method of claim 1, further comprising unblocking the connection elements of the source node by fanning out one or more connections.

8. The method of claim 1, wherein in the event that swapping cannot take place a route is found from the first link node to an intermediate destination node, back to a third link node, and then to the destination node.

9. A controller configured to monitor and control the connections across a Clos network formed of leaf nodes and spine nodes, the spine nodes comprising connection elements, configured to:
identify a request to send a signal from a source leaf node to a destination leaf node that cannot be made via a single spine node;
identify a first spine node comprising a first connection element connected or connectable to the source leaf node, and a second spine node comprising a second connection element connectable to the destination leaf node;
create a combined map of the existing connections between the connection elements on the first spine node and the second spine node with the existing connections shown on a single notional spine node, wherein the notional spine node comprises the first connection element of the first spine node and the second connection element of the second spine node;
identify a connection network on the notional spine node that comprises the first connection element, wherein the connection network is formed of a continuous path of existing connections between connection elements of the notional spine node;
swap, in the event the connection network does not comprise the second connection element, the existing connections made on the first spine node that form at least part of the connection network with the existing connections made on the second spine node that form at least part of the connection network.

10. The controller of claim 9, further configured to form a connection from the source leaf node to one of the first or second spine nodes, and a connection from the chosen spine node to the destination leaf node, further configured to direct a signal from the source leaf node to the destination leaf node through one of the first and second spine nodes.

11. The controller of claim 10, wherein forming a connection from the source leaf node to one of the first or second spine node, and a connection from the chosen spine node to the destination leaf node comprises fanning out an existing connection between the source leaf node to the chosen spine node, and connecting the fanned out connection with the connection element of the chosen spine node connectable to the destination node and then connecting the fanned out connection to the destination node.

12. The controller of claim 10, wherein forming a connection from the source leaf node to one of the first or second spine node, and a connection from the chosen spine node to the destination leaf node comprises fanning out an existing connection between the chosen spine node and the destination leaf node at the destination leaf node.

13. The controller of claim 9, further configured to first identify a spine node with at least two unused connection elements, wherein the first unused connection element is connectable to the source leaf node, and wherein the second unused connection element is connectable to the destination leaf node, wherein a connection can be made across the spine node between the unused spine node connection elements, and in the event such a spine cannot be identified performing the other steps.

14. The controller of claim 9, further configured to unblock the connection elements of the source leaf node by fanning out one or more connections.

15. The controller of claim 9, wherein in the event that swapping cannot take place a route is found from the first spine node to a third leaf node, back to a third spine node, and then to the destination leaf node.

16. A router for directing signals comprising:
a plurality of leaf nodes, wherein each leaf node comprises at least one connection element;
a plurality of spine nodes, wherein each spine node comprises at least two connection elements;
wherein each leaf node is connectable to at least one spine node through a connection between one of the at least one connection elements of the leaf node and one of the at least two connection elements of the spine node;
the router being configured so that a signal from a source leaf node can reach a destination leaf node through a spine node; and
wherein the network is configured, in the event no spine node can connect to both the source leaf node and the destination leaf node, to:
identify a first spine node connected or connectable to the source leaf node and a second spine node connectable to the destination leaf node;
map the existing connections between connection elements on the first spine node and map the existing connections between connection elements on the second spine node;
superimpose said existing connections onto a single connection map;
identify a connection tree that comprises the second connection element, wherein each connection tree is formed of a continuous path of existing connections between connection elements;
swap, in the event the connection tree does not comprise the first connection element, the existing connections on the second spine node that form part of the connection tree, with the existing connections on the first spine node that form part of the connection tree.

17. The router of claim 16, further configured to form a connection from the source leaf node to one of the first or second spine nodes, and a connection from the chosen spine node to the destination leaf node.

18. The router of claim 16, further configured to direct a signal from the source leaf node to the destination leaf node through one of the first and second spine nodes.

19. The router of claim 17, wherein forming a connection from the source leaf node to one of the first or second spine node, and a connection from the chosen spine node to the destination leaf node comprises fanning out an existing connection between the source leaf node to the chosen spine node, and connecting the fanned out connection with the connection element of the chosen spine node connectable to the destination node and then connecting the fanned out connection to the destination node.

20. The router of claim 17, wherein forming a connection from the source leaf node to one of the first or second spine node, and a connection from the chosen spine node to the destination leaf node comprises fanning out an existing connection between the chosen spine node and the destination leaf node at the destination leaf node.
